(19) United States
(12) Patent Application Publication
(10) Pub. No.: US 2019/0223425 A1
(43) Pub. Date: Jul. 25, 2019

(54) Bug-Removal Vacuum Machine

(71) Applicant: Buck Tugel, King City, CA (US)

(72) Inventor: Buck Tugel, King City, CA (US)

(21) Appl. No.: 16/372,810

(22) Filed: Apr. 2, 2019

Related U.S. Application Data
(63) Continuation-in-part of application No. 15/660,379, filed on Jul. 26, 2017.
(60) Provisional application No. 62/367,254, filed on Jul. 27, 2016.
(60) Provisional application No. 62/418,491, filed on Nov. 7, 2016.

(51) Int. Cl. A01M 1/06; A01M 1/22

(52) U.S. Cl. CPC A01M 1/06; A01M 2200/012; A01M 1/223

(57) ABSTRACT

A vacuum machine has a rectangular deck, having a centerline, a width and a length, an underside and an upper side, a front edge and a rear edge, and side edges. Sidewalls extend below the deck along the side edges. There is an opening through the deck, substantially centered between the front edge and the rear edge, and between the sidewalls, a powered air blower coupled through a plenum above the deck to the opening, such that operating the blower draws air through the opening from beneath the deck, a killing mechanism disposed at an outlet from the blower, adapted to kill insects entrained in air drawn through the plenum, and a horizontally-oriented passage coupled to the outlet from the blower, directing air having entrained insects dead or alive away from the machine. The machine travels in the direction of the centerline advancing the first front edge of the deck.

### CROSS-REFERENCE TO RELATED DOCUMENTS

The present patent application is a continuation-in part (CIP) of co-pending non-provisional application Ser. No. 15/660,379, filed Jul. 26, 2017, which claims priority to the filing dates of provisional application 62/367,254, filed on Jul. 27, 2016 entitled “Agricultural Bug Vacuum Machine” and provisional application 62/418,491, filed on Nov. 7, 2016 entitled “Agricultural Bug Vacuum Machine”. Disclosure of prior applications is incorporated herein in its entirety by reference.

### BACKGROUND OF THE INVENTION

### 1. Field of the Invention

The present invention is in the technical area of combatting insect infestation in crops and pertains more particularly to a machine incorporating vacuum for efficiently removing insects from plants.

### 2. Description of Related Art

Vacuum-operated machines are known in the art for operating over plants, for dislodging and killing insects that feed on the growing plants. At the time of the present invention, however, all such machines by design are inefficient in creating a proper air flow over and around the plants to efficiently remove and destroy insects. The problems in the art are, in the view of the present inventor, due to the geometry of elements of the prior-art machines, that direct and manage flow of air brought into the machine to flow around the plants.

### BRIEF SUMMARY OF THE INVENTION

In one embodiment of the invention a bug-removal vacuum machine is provided, comprising a generally horizontally-disposed, substantially planar, rectangular deck, having a centerline, a first width and a first length, an underside and an upper side, a first front edge and a first rear edge, and a first side edge and a second side edge, a first sidewall extending below the deck along the first side edge, and a second sidewall extending below the deck along the second side edge, the sidewalls each having an outer surface facing away from the centerline and an inner surface facing toward the centerline, an opening through the deck, substantially centered between the first front edge, the first rear edge, and between the sidewalls of the planar deck, a powered air blower coupled through a plenum above the planar deck to the opening through the deck, such that operating the blower draws air through the opening from beneath the deck, a killing mechanism disposed at an outlet from the blower, adapted to kill insects entrained in air drawn through the plenum, and a horizontally-oriented passage coupled to the outlet from the blower, directing air having entrained insects dead or alive away from the machine. The machine travels in the direction of the centerline advancing the first front edge of the deck.

In one embodiment the horizontally-oriented passage is substantially open at an end away from the blower, and further comprises a capture tray disposed below the horizontally-oriented passage, for capturing dead insects falling out of the air in the passage. Also, in one embodiment the machine further comprises a vertically-oriented moving continuous screen conveyor disposed in the horizontally-oriented passage, catching insects dead or alive from the air in the passage. Also, in one embodiment the machine further comprises a scraper disposed to dislodge insects from the continuous screen conveyor, and to drop insects dislodged into the capture tray.

In one embodiment of the machine the horizontally-oriented passage is directed toward and beyond the first front edge of the deck, and comprises a downwardly-directed channel coupled to an end of the passage away from the blower, directing the air in the passage downward at a distance from the first front edge of the deck, to dislodge insects on plants ahead of the travel of the vacuum machine. In one embodiment the horizontally-oriented passage coupled to the outlet from the blower directs air having entrained insects dead or alive away from the machine to one side at a right angle to the centerline, further comprising a mechanism having an auxiliary blower, directing air through at least one conduit forward in the direction of travel beyond the first front edge of the deck, and then downward ahead of the advancing vacuum machine, dislodging insects on the plants prior to arrival of the vacuum machine. And in one embodiment the mechanism having an auxiliary blower directs air forward through the at least one conduit, then downward through a plurality of conduits of a length to reach to ground level, with the plurality of conduits closely-spaced laterally in a line at a right angle to the centerline, and having each a plurality of air nozzles, to travel between rows of plants to dislodge insects from the plants.

BRIEF DESCRIPTION OF THE SEVERAL VIEWS OF THE DRAWINGS

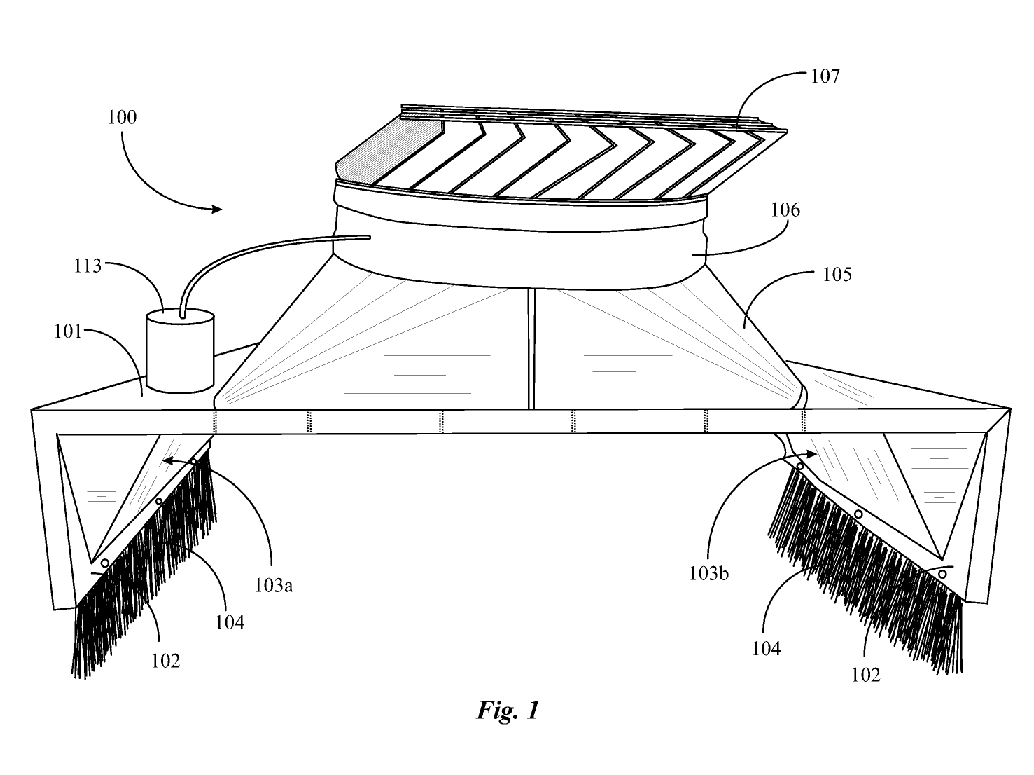

FIG. 1 is a front elevation view of a portion of a vacuum machine in an embodiment of the invention

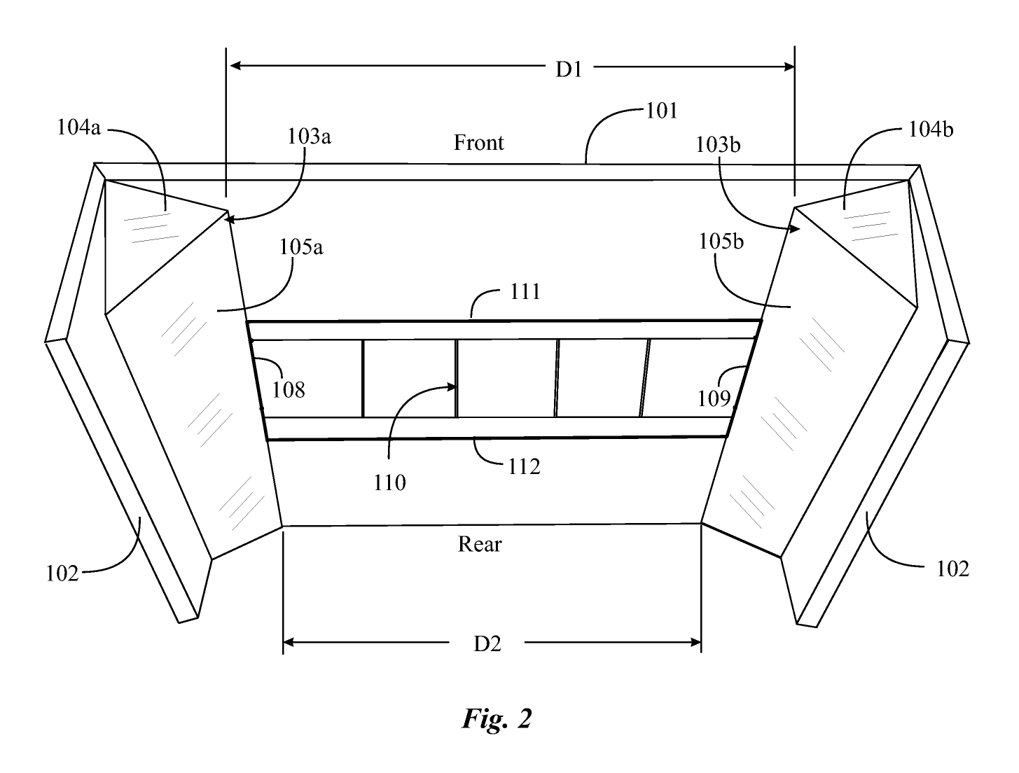

FIG. 2 is a view from underside of the vacuum machine structure of FIG. 1.

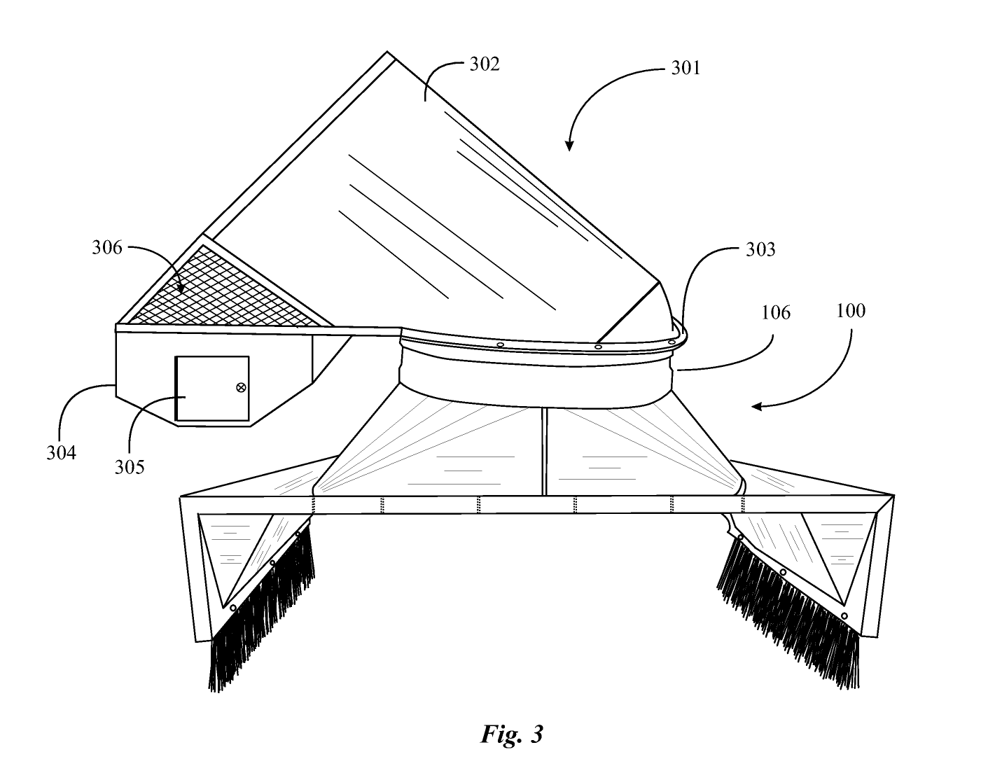

FIG. 3 is a perspective view of the vacuum apparatus of FIGS. 1 and 2 with an additional capturing component.

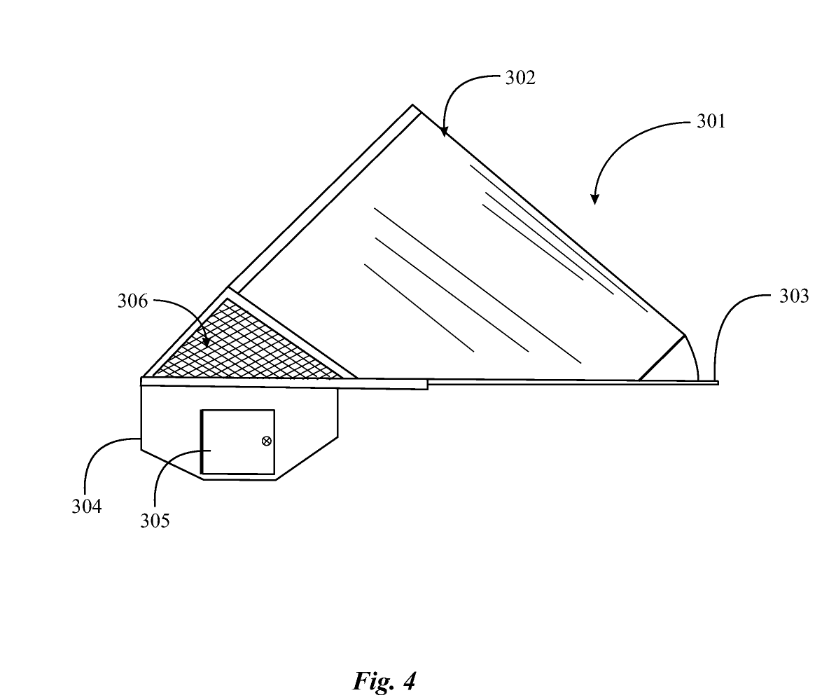

FIG. 4 is an elevation side view of the capturing component of FIG. 3, in an embodiment of the invention.

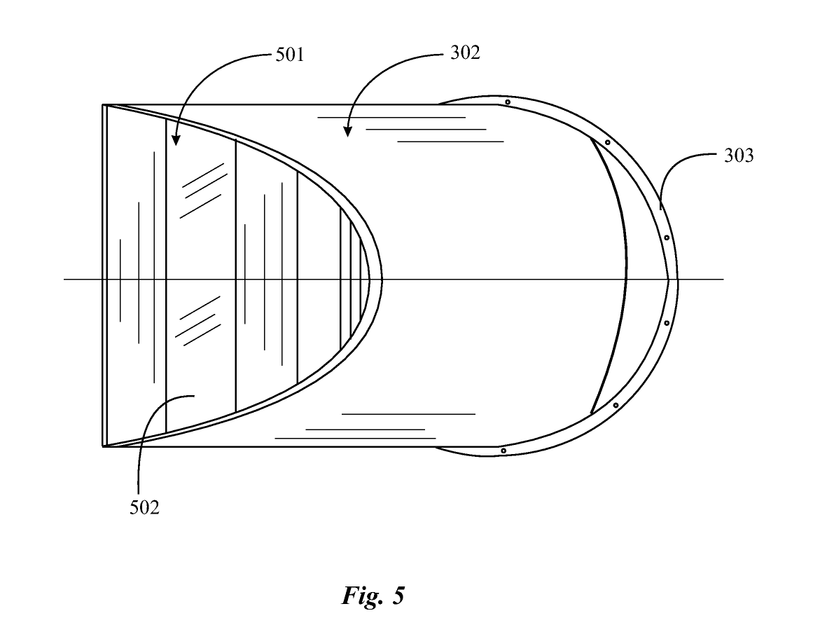

FIG. 5 is a top plan view of the capturing component of FIG. 4.

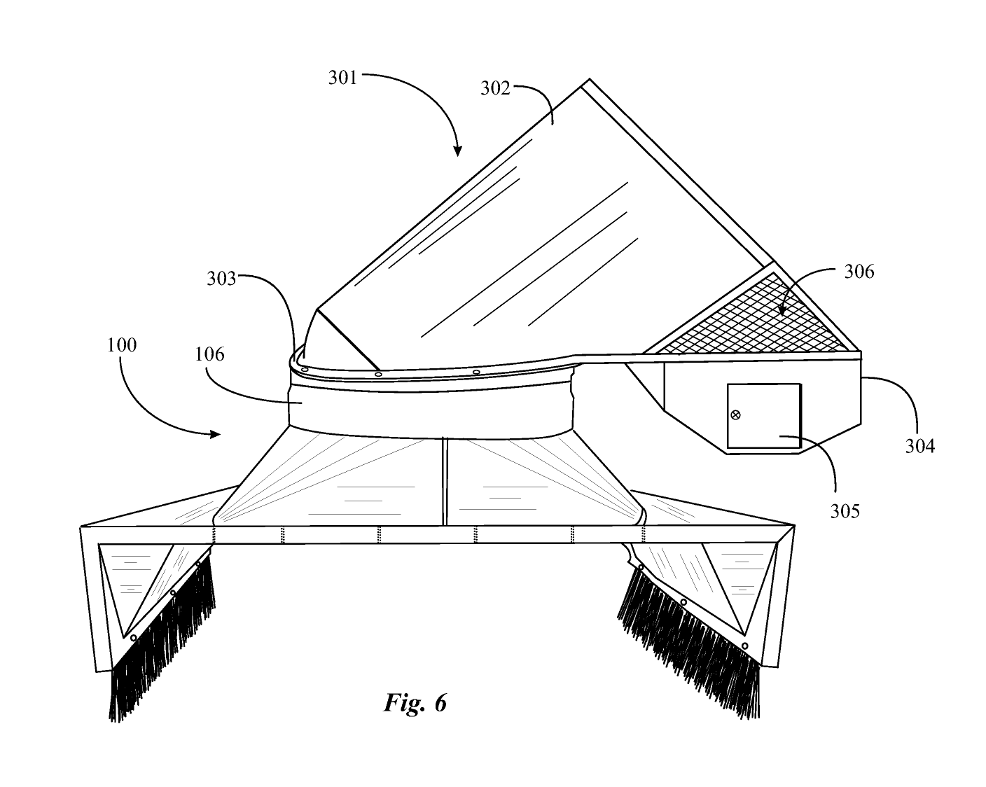

FIG. 6 is a perspective view of the vacuum apparatus of FIGS. 1, 2 and 3 with an upper portion revolved by 180 degrees.

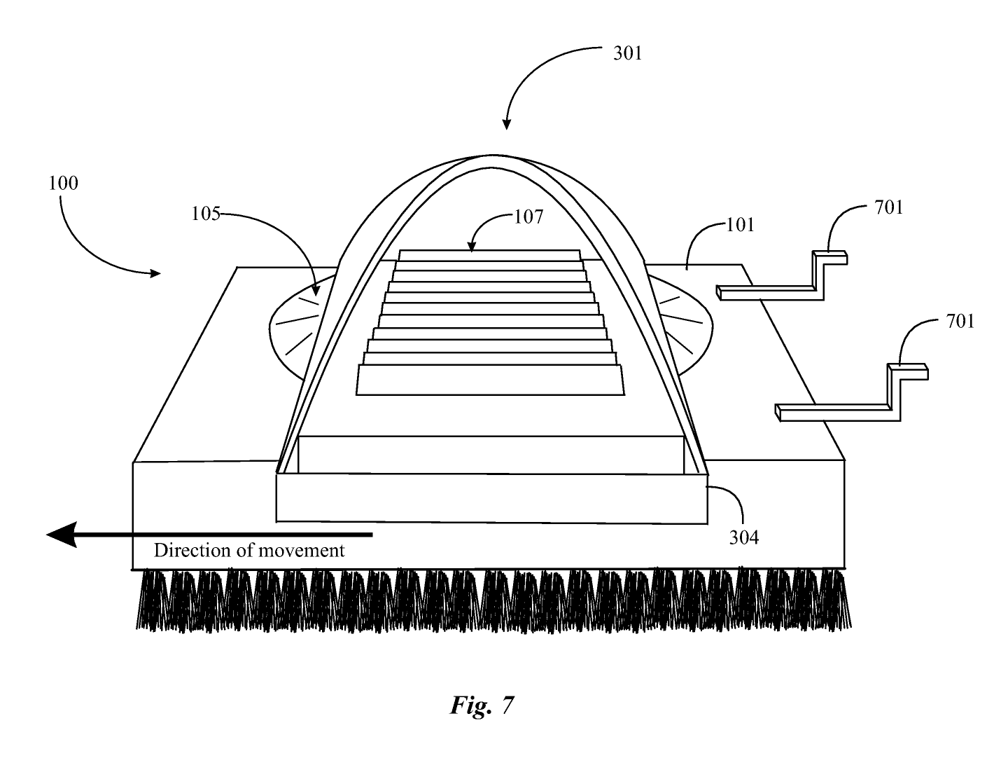

FIG. 7 is a side elevation view of the vacuum apparatus of FIG. 6, with the apparatus of FIG. 6 rotated ninety degrees with the wider portion of the vacuum apparatus propelled to the left.

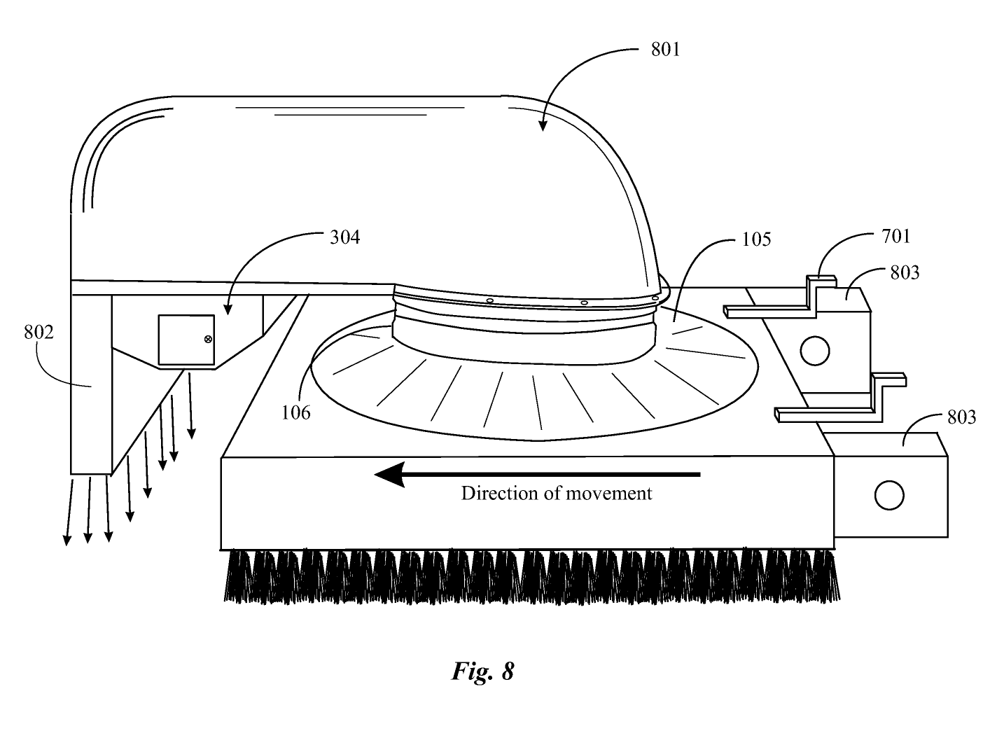

FIG. 8 is a side elevation view of a vacuum apparatus in yet another embodiment of the invention.

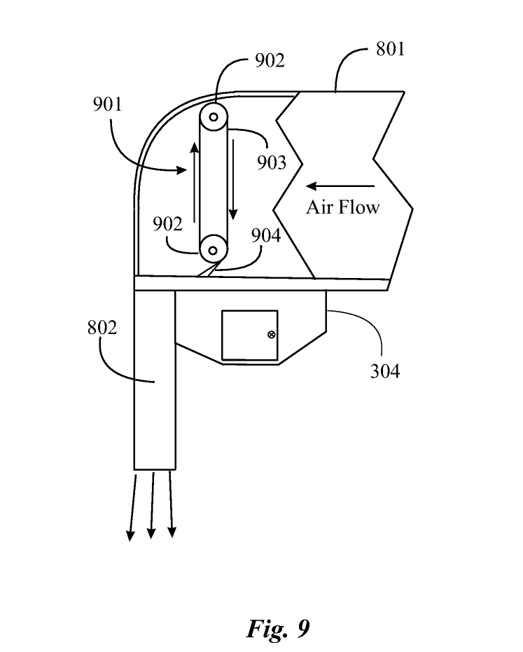

FIG. 9 is a partial section view of a portion of structure 801 od FIG. 8.

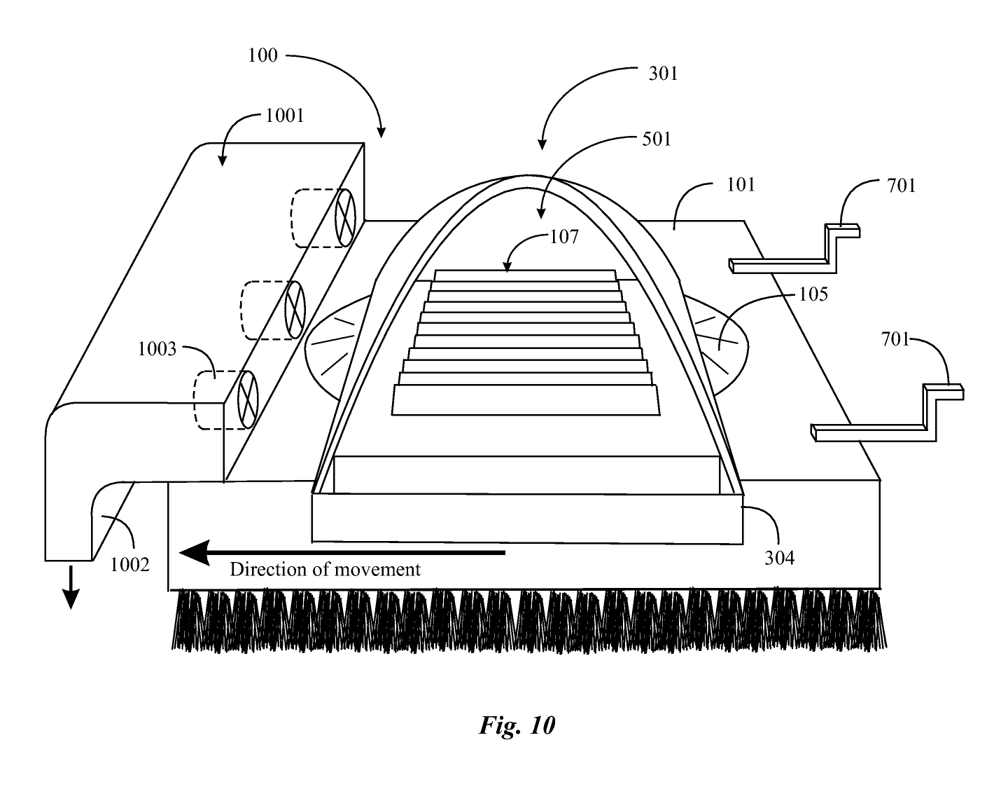

FIG. 10 is a perspective view of a machine with air projected to the front in an embodiment of the invention.

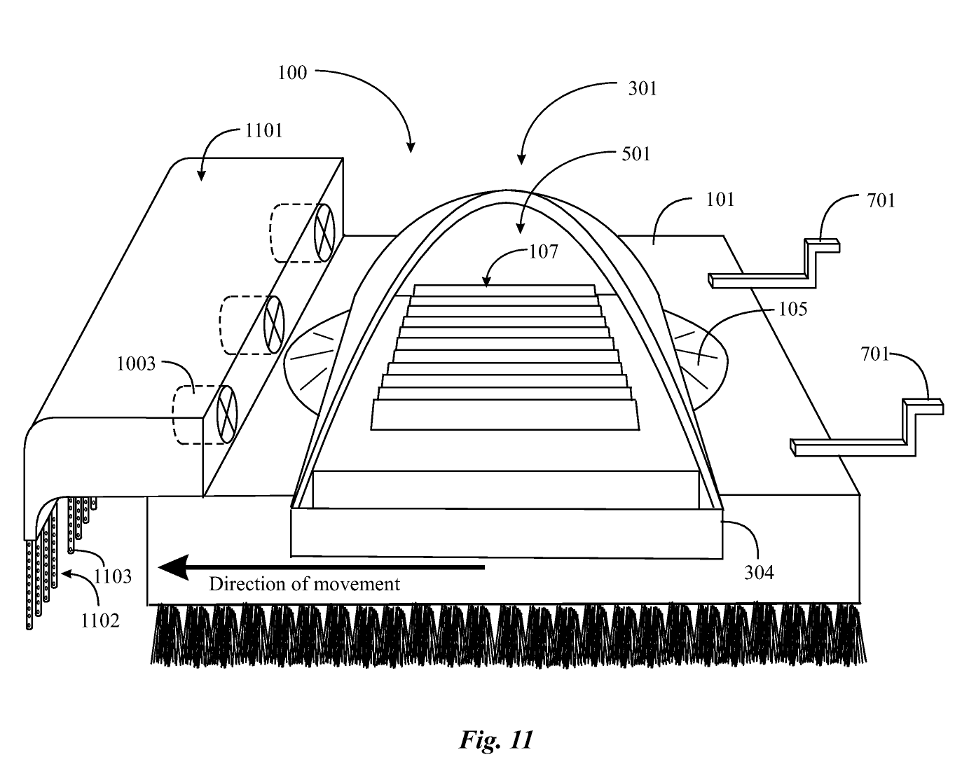

FIG. 11 is a perspective view of a machine with air directed to the front in individual channels in an embodiment of the invention.

### DETAILED DESCRIPTION OF THE INVENTION

Referring now to FIG. 1, a partial structure 100 of an insect-removal machine is shown in perspective in an elevation view from in front of the machine. Structure 100 is in part based on a deck 101, which may be fabricated from a metal like aluminum, or other suitable material. There are two side walls 102 extending downward from opposite edges of deck 101, and brushes 104 fastened along a bottom edge of each of sidewalls 102. The brushes trail along ground level and provide for variation in the height at which structure 100 may be carried along and over growing plants, from which it may be desired to remove insects. In some circumstances, the brushes may contact the ground and be somewhat deformed, and in other instances the brushes may travel a short distance above ground level. The brushes also provide a barrier to of air entering the structure from the sides below the side walls.

A plenum 105 connects between an opening in deck 101 and a blower 106, which blower forces air upward out of the structure from the plenum, and in some embodiments through a killing mechanism 107, which serves to kill insects drawn into and through the structure. The killing mechanism may take several forms, but is, in exemplary embodiments, a matrix of panels or wires formed over the path of the airflow from the blower, the matrix electrically charged in a manner that insects coming into contact with elements of the matrix are electrocuted.

The electrical grid is not always used, and in some embodiments a reservoir 113 contains a vinegar solution. There is a 12-volt pump providing the solution through a line 114 to a spray nozzle pointed to the fan in the airstream below the fan. The vinegar solution is known by the inventor to be lethal to insects captured.

The opening through the deck is shown in enabling detail in FIG. 2 described below. There are two baffle elements 103a and 103b positioned inside of each of side walls 102, and the baffle elements guide air drawn into the region between the side walls upward to and through the opening in the deck.

FIG. 2 is a view from underside of the vacuum machine of FIG. 1. The opening through deck 101 referred to above, but not seen in FIG. 1, is seen in FIG. 2 as defined by long edges 111 and 112, across the width of the structure, and short edges 108 and 109 in the direction of the length of the structure, in the direction of travel in use. Baffles 103a and 103b are mirror images of one another, and comprise a triangular cross section, with one baffle positioned along the inside of side wall 102 on each side of the machine. Baffle 103a has a front surface 104a, and a side surface 105a, while baffle 103b has a front surface 104b and a side surface 105b. It may be seen in FIG. 2 that an inside edge of baffle 103a coincides with edge 108 of the opening through the deck, and an inside edge of baffle 103b coincides with edge 109 of the opening.

The front of the baffle structure at the deck level, represented by dimension D1, is wider than at the rear of the machine, represented by dimension D2. This tapered effect causes the opening through the deck to be trapezoidal in nature, such that edges 111 and 112 are parallel, but edge 111, being closer to the front, is a bit longer than edge 112, which is closer to the rear. Opposite edges 108 and 109 are of the same length but extend at opposite angles. A welded matrix of rods 110 are not essential to the invention but form a barrier for relatively large debris that might be drawn into the machine in operation, such as soda cans, plastic membranes, and the like. This matrix may be more closely spaced, or less closely spaced, in alternative embodiments, or may be left out altogether.

An important purpose of baffles 103a and 103b, and the placement of the baffles, particularly the edges coinciding with the edges of the opening through the deck, is to control and guide air flow into the structure, and upward into plenum 105, to best advantage. Referring again to FIG. 1, structure 100 in that view is upright in an aspect that the machine would be carried by a tractor along a path, with side walls 102 spanning opposite sides of one or more rows of plants in the path, with brushes 104 trailing at or near ground level. Two or more structures 100 may be carried side by side and spaced laterally to service more rows of plants simultaneously. The direction of travel is, in one embodiment, with the wide end forward, which in FIG. 1 implies that the machine would traverse toward the viewer.

As structure 100 is carried along a path, blower 106 operates at high capacity to draw air, primarily from the front of the structure, over and around the details of plants, capturing insects from the plants, and upward through plenum 105, and out through killing mechanism 107. The air moved by the blower is drawn in from primarily the front of the machine above and on both sides of plants in the path, and is guided inward by the tapered shape of the baffles and side walls, which serves to increase the velocity of the air, and then upward by surfaces 105a and 105b of the baffles, and the air enters the opening through the deck with a strong upward component of flow. In the figures, the surfaces 105a and 105b are depicted as essentially planar, but in some cases, there may some curvature to the guiding surface. The more important feature is that the edges of the baffles align with the edges of the opening through the deck.

In prior art structures, the side walls are typically curved from vertical to horizontal, and there are no baffles, so air is directed horizontally over the opening through the deck, from both sides, creating a collision situation wherein a substantial portion of the air drawn in at first is not guided into and through the opening, but is deflected turbulently downward, such that insects are not efficiently trapped and drawn into the turbine and into the killing mechanism 107.

FIG. 3 is a perspective view of the insect-gathering structure 100, with an additional structure 301 for capturing and collecting insects, typically dead insects, that have been drawn from plants through blower 106. Structure 100 and structure 301 together comprise a bug-removal and collection machine. Capturing structure 301 comprises a flange 303, to mate with a companion flange as part of structure 100, a hood-like semi-cylindrical structure 302, and a collection tray 304 below the level of flange 303 to one side. The tray is for collecting insects and portions of insects that are captured and suctioned through blower 106. In embodiments incorporating this capture structure it is necessary that the upper extremity of structure 100 have a flange matching that of structure 301, enabling the two units to be joined, and for the capture structure to be removed at need, to access and maintain or repair portions of both units, such as the blower and the screens 107 described above.

Captured insects drawn through blower 106 are directed with the flow of air induced by the blower to one side, toward the capture tray 304. A portion of sides of structure 302, labeled 306 in FIG. 3, is restricted only by an expanded metal screen in one embodiment, and there is a similar opening above the capture tray at the other end of the capture tray. In one embodiment, the capture tray may be removably mounted to the structure, and in other embodiments the tray may be a contiguous part of the structure. In some embodiments, there is a door 305 enabling removal of insects and debris. A purpose of screens 306 is to allow air to escape the structure, rather than creating a back-pressure that would impair the operation of the machine.

FIG. 4 is a side elevation view of structure 301 showing the capture structure removed from the blower structure at the flange interface. FIG. 5 is a top plan view of capture structure 301 showing the flange 303 and the relationship of the hood structure 302 to the flange and the capture tray. End 501 of the hood structure is shown completely open in this view, and horizontal surface 502 is the bottom of tray 304. In most embodiments opening 501 is covered with an expanded metal screen, as is shown for opening 306 in FIG. 3. The screen is not shown, so detail below the screen may be better displayed in the figure.

A purpose of openings 306 and 501 is to provide very little restraint for air brought up through the blower, such that the air easily expands and the pressure drops, so insects entrained will tend to fall into the collection tray rather than be expelled through the screened openings.

In one embodiment, the collection structure is aluminum, and it is desirable that the weight of the structure be minimized. Other metals may also be suitable, and the structure is not limited to aluminum. In some embodiments, the bug-vacuum machine in embodiments of the invention is carried by a tractor as a suspended cantilever structure. I other embodiment, the machine may be mounted on a rolling structure, having wheels that roll along the ground.

FIG. 6 is a perspective view of the vacuum apparatus of FIGS. 1, 2 and 3 with upper portion 301 revolved by 180 degrees. This re-orientation is readily accomplished, as the lower and upper portions are joined by flange interface 303. As stated elsewhere in this specification, the direction of travel is toward the wider end, which will be toward the viewer in both FIGS. 3 and 6. The entire structure is suspended from the forward structure of a tractor and propelled forward by the tractor as shown and described below.

FIG. 7 is a side elevation view of the vacuum apparatus of FIG. 6, with the apparatus of FIG. 6 rotated ninety degrees with the wider portion of structure 100 propelled to the left, as seen by the arrow in FIG. 7. In this view the collector apparatus 301 has opening 501 toward the viewer. As described with reference to FIG. 3 above, opening 501 is covered with an expanded metal screen, but the screen is removed in this view to show internal structure. Killing structure 107 is, as described above, in this instance a matrix of panels or wires formed over the path of the airflow from the blower, the matrix electrically charged in a manner that insects coming into contact with elements of the matrix are electrocuted. The dead insects are not collected in this structure but carried with the airflow into a region of expanding volume to slow the air velocity. The dead insects drop into collector tray 304, and the air continues out through the expanded metal screen over opening 501, in this case, to the left of the direction of movement of the vacuum apparatus. In this embodiment two carrier structures 701 are shown bolted or welded to deck 101. These structures interface with carrier apparatus on the front of the tractor that carries and propels the vacuum apparatus. The tractor interface is capable of raising and lowering the vacuum apparatus to adjust the relationship with plants and the ground level.

FIG. 8 is a side elevation view of a vacuum apparatus in another embodiment of the invention. In the embodiment represented in FIG. 8 the lower part of the apparatus, illustrated in detail in FIGS. 1 and 2 in particular, is unchanged, including the electrified panels 107, which are present but not shown in FIG. 8. A new upper structure 801 is provided in place of structure 301 of FIG. 3. Structure 801 fastens to flange 303 of the lower assembly by a mating flange.

Upper structure 801 channels air, after passing through the panels 107 upward and forward, in the direction of movement of the vacuum apparatus as carried by a tractor or other vehicle. Dead insects drawn into the apparatus are carried along, and removed to trough 804, similar to trough 304 in FIG. 3, by a moving screen not shown in FIG. 8 but described in enabling detail in FIG. 9. Air passing through the insect removal screen is then directed downward in a passage 802, creating an air curtain across the width of the apparatus at a short distance in front of the leading edge of the apparatus.

The inventor has discovered that insects often try to escape the apparatus by flying forward in the direction of travel of the apparatus, as the apparatus approaches. The air curtain provided by the air directed downward through passage 802 prevents such escape and draws these insects into the apparatus as well. The air curtain provided by downward-directed passage 802 also serves to dislodge insects on plants.

A further functionality of the apparatus depicted exemplary in FIG. 8 is that the air passing through the system is re-circulated, entering and passing through the apparatus again and again. Such recirculation tends to maximize capture of live insects and disposal of dead insects.

Further to the above, in the embodiment represented by FIG. 8 two additional auxiliary blowers 803 are positioned near the rearward corners of the apparatus, and direct air drawn into the blowers into the rearward interface of the apparatus and may be selectively aimed upward and inward toward plants over which the apparatus may be passing. Adjustment to the direction, and in some cases the volume, of air from these auxiliary blowers may be made differently for different plants.

FIG. 9 is a partial section of the apparatus of FIG. 8 taken at the location of trough 304 showing a screen conveyor placed in the path of air in structure 801, to efficiently remove dead insects in the air to trough 304. A portion of the outer walls of structure 801m is shown removed to illustrate the screen conveyor inside.

In this example screen conveyor 901, comprising a continuous screen 903 is implemented over two pulleys 902 at least one of which is motor-driven, so the screen conveyor moves in a continuous path as shown by arrows. Air passing to the left in the figure, from the blower, entraining insects, mostly dead, passes through the opposite layers of the moving screen. Dead insects are caught on the outer surface of the descending screen that is the first layer the air encounters. Dead insects are held against the screen by the pressure of the moving air, and at the bottom, just above collection trough 804, the dead insects drop off the screen into the collection trough. A scraper 904 may be implemented at this point to be sure all insects come off the screen, rather than being carried back around the moving conveyor.

FIG. 10 illustrates a bug-removal vacuum machine 301 with the exhaust from the blower directed to one side, in this instance toward the front of the page with the machine moving to the left. In this example there is a plenum 1001 along the front with blowers 1003 directing air into the plenum and down through a vertical channel onto plants ahead of the travel of the machine, to dislodge insects from plants before the main part of the machine reaches the plants.

FIG. 11 illustrates a bug-removal machine similar to that shown in FIG. 10, having separate channels 1102 in distinct groups directed downward from plenum 1101. Channels 1101 are of a length to reach nearly to ground surface and spaced laterally to travel between rows of plants. Each channel 1101 has air outlets 1103 directed to the side to impinge on plants from between the rows of plants.

The skilled artisan will understand that the embodiments described herein are exemplary only, and many details may vary in different embodiments within the scope of the invention. In various alternative embodiments, different materials may be used, different blower mechanisms may be used, power may vary, dimensions may vary, and many other details may differ within the scope of the invention.

1. A bug-removal vacuum machine, comprising:
a generally horizontally-disposed, substantially planar, rectangular deck, having a centerline, a first width and a first length, an underside and an upper side, a first front edge and a first rear edge, and a first side edge and a second side edge;
a first sidewall extending below the deck along the first side edge, and a second sidewall extending below the deck along the second side edge, the sidewalls each having an outer surface facing away from the centerline and an inner surface facing toward the centerline;
an opening through the deck, substantially centered between the first front edge, the first rear edge, and between the sidewalls of the planar deck;
a powered air blower coupled through a plenum above the planar deck to the opening through the deck, such that operating the blower draws air through the opening from beneath the deck;
a killing mechanism disposed at an outlet from the blower, adapted to kill insects entrained in air drawn through the plenum; and
a horizontally-oriented passage coupled to the outlet from the blower, directing air having entrained insects dead or alive away from the machine;
wherein the machine travels in the direction of the centerline advancing the first front edge of the deck.

2. The bug-removal vacuum machine of claim 1 wherein the horizontally-oriented passage is substantially open at an end away from the blower, and further comprises a capture tray disposed below the horizontally-oriented passage, for capturing dead insects falling out of the air in the passage.

3. The bug-removal vacuum machine of claim 2 further comprising a vertically-oriented moving continuous screen conveyor disposed in the horizontally-oriented passage, catching insects dead or alive from the air in the passage.

4. The bug-removal vacuum machine of claim 3 further comprising a scraper disposed to dislodge insects from the continuous screen conveyor, and to drop insects dislodged into the capture tray.

5. The bug-removal vacuum machine of claim 1 wherein the horizontally-oriented passage is directed toward and beyond the first front edge of the deck, and comprises a downwardly-directed channel coupled to an end of the passage away from the blower, directing the air in the passage downward at a distance from the first front edge of the deck, to dislodge insects on plants ahead of the travel of the vacuum machine.

6. The bug-removal vacuum machine of claim 1 wherein the horizontally-oriented passage coupled to the outlet from the blower directs air having entrained insects dead or alive away from the machine to one side at a right angle to the centerline, further comprising a mechanism having an auxiliary blower, directing air through at least one conduit forward in the direction of travel beyond the first front edge of the deck, and then downward ahead of the advancing vacuum machine, dislodging insects on the plants prior to arrival of the vacuum machine.

7. The bug-removal vacuum machine of claim 6 wherein the mechanism having an auxiliary blower directs air forward through the at least one conduit, then downward through a plurality of conduits of a length to reach to ground level, with the plurality of conduits closely-spaced laterally in a line at a right angle to the centerline, and having each a plurality of air nozzles, to travel between rows of plants to dislodge insects from the plants.
